(19) United States
(12) Patent Application Publication
(10) Pub. No.: US 2026/0034461 A1
(43) Pub. Date: Feb. 5, 2026

(54) COMPUTERIZED SYSTEMS AND METHODS FOR STORY DEVELOPMENT ENVIRONMENT INCORPORATING ROLE-PLAYING LANGUAGE AGENTS

(71) Applicant: Oren Tzvi HORWITZ, Hod HaSharon (IL)

(72) Inventor: Oren Tzvi HORWITZ, Hod HaSharon (IL)

(21) Appl. No.: 19/285,047

(22) Filed: Jul. 30, 2025

Related U.S. Application Data
(60) Provisional application No. 63/677,516, filed on Jul. 31, 2024.

(51) Int. Cl. A63F 13/822; A63F 13/53; A63F 13/55

(52) U.S. Cl. CPC A63F 13/822; A63F 13/53; A63F 13/55; A63F 2300/65; A63F 2300/807

(57) ABSTRACT

Provided herein are computerized systems, methods and user interface, for story development environment incorporating role-playing language agents, configured to provide, manage, simulate and integrate contextual points of view of ensemble characters.

### CROSS REFERENCE TO RELATED APPLICATION

This application claims the benefit of priority of U.S. Provisional Patent Application No. 63/677,516, filed Jul. 31, 2024, the contents of which are all incorporated herein by reference in their entirety.

### FIELD OF THE INVENTION

The disclosure generally relates to computerized systems and methods for story development environment incorporating role-playing language agents, configured to provide, manage, simulate and integrate contextual points of view of ensemble characters.

### BACKGROUND

Screenplays (aka scripts) are written stories that use standardized text formatted to describe the dialogue, actions and expressions of characters along a story's timeline. Screenplays are of special interest as they are common practice for productions such as movies, TV series, plays, television shows, advertisements, and the like. Screenplays can be written for completely new stories, or adapted from an existing written work (e.g. a book). Various products are designed to create and edit stories and screenplays, including, Final Draft, Celtx, Fade In, Movie Magic Screenwriter, WriterDuct, MS-Word, Trelby, Scrivener, etc.

Analogous to the world of “mixing” music, stories are essentially “mixed” from their characters' Point Of View (POV)—either implicitly or explicitly, where each character's POV may be conceptualized as a distinct “channel”. Yet, although music-mixing products are designed to manage, simulate and integrate multiple channels (where some channels are “simulated” instruments—e.g. Pianos and Percussion), this is not the case with stories editing products. Existing story editing products categorically do not provide the system and methods to manage, simulate and integrate character's POV as distinct channels in a story. Notably, this is not a design choice, but, until recently, a technical limitation to simulate and integrate context-aware, human-like character cognition into a story timeline.

The industry term Role-Playing Language Agents appears in scholarly articles starting early 2023, soon after the arrival of Large Language Models (LLMs). LLMs firstly enabled computers to display human-like cognition (general and social intelligence, including human psychological traits, reasoning, in-context learning, instruction following, emotions, sentience, etc.). Some concepts and applications of Role-Playing Language Agents are presented in Shanahan et al, 2023; Christopher et al, 2023; and Park et al, 2023.

Thus, there is a need in the art for computerized systems and methods for a story development environment suitable to provide, manage, simulate and integrate the unique POV of various characters in the story, using Role-Playing Language Agents.

### SUMMARY

According to some embodiments, there are provided herein Story Development Environment (SDE) computerized systems and methods. According to some embodiments, there are provided herein computerized systems and methods for a story development environment suitable to manage, simulate and integrate the unique POV of various characters in the story, each as a distinct “channel”, using Role-Playing Language Agents. As detailed herein, the systems, method and user interface (UI) disclosed herein apply Role-Playing Language Agents and Context Engineering technologies to story development, in the SDE. Advantageously, the SDE enables authors to define rich and believable characters as Role-Playing Language Agents, using a user interface that requires no psychology training or background. Authors can then communicate with their story's characters, and engage them within story scenes, in-character, in-context and in accordance with their history, motivations, inter-relationships, behavioral profile and tendencies. Story's characters as Role-Playing Language Agents can help authors examine their specific points of view, and explore different plot trajectories. They can help directors, editors, studio executives and actors better understand characters and their motives. Additionally, authors retain full control over each and every detail of the story, and can stir and direct the Role-Playing Language Agents and the plot towards any twist, turn and resolution.

According to some embodiments, there are provided herein computerized systems, methods and user interface, utilizing Role-Playing Language Agents that focus on the cognitive and personality modality of story characters, as opposed to the mostly physical-modality that the term Virtual characters represents in virtual reality environments and video games.

According to some embodiments, the systems and methods disclosed herein can advantageously assist various kinds of authors (experienced, novice or aspiring) in the process of writing formatted screenplays and free format stories with complex, rich and believable characters.

According to some embodiments, the systems and methods disclosed advantageously provide context management, simulation, and integration of characters' POV in every point-in-time along a story progression. The context includes, for example, but not limited to, such information as the details of the scene (that may be considered as the “present-time” for the character), details of the scenes the character participated in “past-times” (relative to the present-time), the character's inner-dialogues in the present-time and past-times (through which we can learn the character's state-of-mind and perception of past events, possible eventualities, and of other characters and their motivations in the story), the character's personality and behavioral patterns, etc.

The invention advantageously introduces a POV-mixing system and methods, to simulate and associate various characters' POVs (including, for example, what the character might think, assume, believe, feel, plan, act or say) to points-in-time along a story script progression.

According to some embodiments, the system simulates a character's POV at any point-in-time along the story progression, by dynamically determining and retrieving the relevant context of the POV, the context being the subset of the story that is “visible” /accessible (information-wise) to the character at that point-in-time, while excluding irrelevant story content such as future scenes, other characters' inner-dialogues, story events that are unknown to the character, and the like. This context-engineering mechanism (management, storage, retrieval and filtering), using, for example, Named Entity Recognition (NER), document metadata-tagging and parsing, vector embedding and storage, and Retrieval-Augmented Generation (RAG), provides the essential context for a Role-Playing Language Agent to faithfully simulate the character's POV and integrate it back into the respective story point-in-time.

Moreover, whereas traditional script writing tools treat a story as a flat text document, the computerized systems and methods disclosed herein introduce an extended-script that includes not only the flat text document, but all the elements of one or more ensemble-characters, including their personality, behavioral patterns, and inner-dialogues at every scene and point in time along the story progression. The extended-script together with the context-engineering mechanism enables to manage, store, retrieve, filter and integrate the essential context for every ensemble-character and scenario.

According to some embodiments, advantageously, the backend engine of the systems and methods disclosed herein is designed to operate in a standalone or a distributed computing architecture enabling the CPLA coordinator module to dynamically select between locally hosted fine-tuned LLMs or remote LLM APIs based on latency, cost, simulation fidelity and resource availability. Accordingly, the systems and methods disclosed herein can advantageously enable multi-user collaborative editing.

According to some embodiments, the systems and methods disclosed herein enable each ensemble-character's behavioral tendencies to be created then represented as a behavioral vector, derived as a combination of free-format descriptive text and multiple personality archetypes. Advantageously, the behavioral vector allows fast retrieval and computation of each ensemble-character's most probable behavioral responses to new scenarios.

According to some embodiments, there is provided a computerized method for providing a story development environment (SDE) generating and/or updating a story incorporating role-playing language agents, the method includes the steps of:
i) receiving, by a backend engine, an extended script;
ii) if the extended-script does not include an ensemble-character, defining at least one ensemble-character, being configured with a character profile, and implemented as a Character-Playing-Language-Agent (CPLA), to enable simulation of contextual Point Of View(s) (POV) of the ensemble-character at any point-in-time along the story progression;
iii) for any point in time along the story progression and any ensemble-character, dynamically generating a context for a potential POV of the ensemble-character, utilizing the backend engine, a CPLA coordinator module and an extended-script storage, wherein the context includes: filtered story history of the character comprising only scenes that are relevant to the ensemble-character at said point in time and/or until said point in time, inner-dialogue(s) of the ensemble-character at and until said point in time; personality and behavioral patterns of the ensemble-character, or any combinations thereof;
iv) generating, utilizing the backend engine, the CPLA coordinator module, and the context, a simulated response of the ensemble character, wherein a response describes what the ensemble-character think, feel, plan, act and/or say, wherein the simulated response manifestation includes: a character inner-dialogue stream associated with any point in time within the story progression, an off-screen dialogue between multiple ensemble-characters, an in-story dialogue entry and/or an in-story description entry;
v) integrating the simulated response of the ensemble-character into the extended script; and
vi) updating the extended-script storage with the most updated extended script.

According to some embodiments, one or more of the steps of the method may be repeated. In some embodiments, the steps of the methods are iterative.

According to some embodiments, defining the at least one ensemble-character further comprises dynamically computing a similarity measure between the ensemble-character description and a plurality of predefined psycholinguistic personality archetypes stored in a database, and automatically deriving behavioral patterns for the character, from behavioral patterns of the most similar predefined archetypes.

According to some embodiments, integrating the simulated response into the extended script may include utilizing specific metadata tags to enable: identification and retrieval of additional context to be utilized in other POVs and/or identification, retrieval and/or visual representation of the POV(s).

According to some embodiments, the backend engine may be further configured to generate simulated response(s) for multiple ensemble-characters simultaneously, within a shared extended-script.

According to some embodiments, the method may further allow multiple users to simultaneously interact with one or more ensemble-characters in parallel.

According to some embodiments, there is provided a system for generating and/or updating a story incorporating role-playing language agents, the system includes one or more processors configured to execute the method as disclosed herein.

According to some embodiments, there is provided a non-transitory computer-readable recording medium storing instructions that, when executed by one or more processors, cause the one or more processors to perform method for generating and/or updating a story incorporating role-playing language agents, as disclosed herein.

According to some embodiments, there is provided a user interface for a story development environment (SDE) incorporating role-playing language agents, the user interface includes:
i) a story editing panel configured to:
   a) display and/or edit a textual representation of an extended-script of the story, comprising character names, scenes, POVs, dialogues and/or inner dialogues;
   b) visually differentiate characters that are ensemble-characters from non-ensemble-characters; and
   c) visually indicate, by indicators, associations between points-in-time along the story progression and ensemble-characters' POV and/or inner-dialogues, wherein selection of said indicator enables initiation of an interaction with the ensemble-character at that point-in-time;
ii) ensemble character panel configured to generate ensemble character(s); and
iii) a character interaction panel configured to display a stream of interactions between a user and at least one ensemble-character;
wherein the user interface is configured to dynamically retrieve and/or update the extended-script from and/or to a backend engine.

According to some embodiments, the indicator may further enable the user to select at least one of: initiating an inner-dialogue, initiating a script dialogue, or invoking an ensemble-character creation wizard.

According to some embodiments, the ensemble character panel includes a behavioral wizard configured to dynamically generate differentiating questions based on an evolving internal psychological model of the ensemble-character.

According to some embodiments, the behavioral wizard may be further configured to enable selection of a subset of potential behavioral patterns, derived from the psychological model of the ensemble-character.

According to some embodiments, the ensemble-character panel may facilitate collaborative multi-user editing of the extended script, by displaying indicators for other users currently modifying the same extended-script.

According to some embodiments, there is provided a computerized system for generating a story development environment (SDE) incorporating role-playing language agents, the system includes:
i) a backend engine including:
   (1) a CPLA coordinator module configured to simulate an ensemble-character by dynamically generating a context for POV of the ensemble-character, wherein the context includes: filtered story history of the character including only scenes that are relevant to the ensemble-character at said point in time and/or until said point in time, inner-dialogue(s) of the ensemble-character at and until said point in time, personality and behavioral patterns of the ensemble-character, or any combinations thereof;
   (2) a set of one or more large language models and CPLA models trained on behavioral data for role-playing story characters; and
   (3) an extended-script storage for storing a story text extended with character's POVs and metadata tags; and
ii) an interface configured to enable communication between frontend modules of one or more users and the backend engine;
wherein the system is configured to maintain consistency of the POVs of ensemble-characters along any point in time within the story progression.

According to some embodiments, the backend engine and the frontend modules are functionally associated on a common computation device.

According to some embodiments, the interface is a network interface and wherein the backend engine and the frontend modules are executed on separate computing devices.

According to some embodiments, the backend engine may further include a behavioral archetype database mapping personality traits to expected behavioral patterns for character simulation.

According to some embodiments, the backend engine may further include a behavioral archetype module configured to dynamically compute a similarity measure between the ensemble-character description and a plurality of predefined psycholinguistic personality archetypes stored in a database, and automatically derive behavioral patterns for the character, from behavioral patterns of most similar predefined archetypes.

According to some embodiments, the CPLA coordinator module is configured to orchestrate both internal language models and external large language model APIs, to generate ensemble-character simulations.

According to some embodiments, the backend engine is configured to dynamically filter story history of the ensemble character, comprising only scenes that are relevant to the ensemble-character at a point in time and/or until said point in time of the story, inner-dialogue(s) of the ensemble-character at and until said point in time, or any combinations thereof.

According to some embodiments, the CPLA coordinator module is configured to support multi-ensemble character dialogues, wherein multiple ensemble-characters engage in a simulated off-screen conversation, independent of a user.

According to some embodiments, the backend engine may be deployed in a distributed computing architecture comprising cloud servers and local processing units.

Certain embodiments of the present disclosure may include some, all, or none of the above advantages. One or more other technical advantages may be readily apparent to those skilled in the art from the figures, descriptions, and claims included herein. Moreover, while specific advantages have been enumerated above, various embodiments may include all, some, or none of the enumerated advantages.

Unless otherwise defined, all technical and scientific terms used herein have the same meaning as commonly understood by one of ordinary skill in the art to which this disclosure pertains. In case of conflict, the patent specification, including definitions, governs.

### BRIEF DESCRIPTION OF THE DRAWINGS

The following brief and detailed descriptions are described with reference to the accompanying figures. In the figures, the leftmost digit of a reference number identifies the figure in which the reference number first appears. The use of the same reference numbers in different figures indicates similar or identical items.

FIG. 1 is a schematic representation of an architecture of an SDE in which the workflow, systems, methods and user-interface disclosed herein may be implemented, in accordance with various embodiments.

FIG. 2A and FIG. 2B each illustrate example functionalities provided by a user interface of a platform adapted to perform the workflows of an SDE that includes profiles of pre-defined Ensemble-characters. They may be described in conjunction with FIG. 3 which provides schematic representations of the workflow, operations and visual element of FIG. 2A and FIG. 2B.

FIG. 3 is a flowchart of example operations that can be performed to provide an SDE which deploys profiles of Ensemble-characters that were already created or defined, in accordance with various embodiments.

FIG. 4A, FIG. 4B and FIG. 4C each illustrate example functionalities provided by a user interface of a platform adapted to perform the workflows of defining (or creating) new Ensemble-characters in an SDE. They may be described in conjunction with FIG. 5 which provides a schematic representation of the workflow, operations and visual element of FIG. 4A, FIG. 4B and FIG. 4C.

FIG. 5 is a flowchart of an example process used to create the profile of a new Ensemble-character, and fine tune existing Ensemble-characters using an iterative, dynamic and flexible lingual questionnaire, in accordance with various embodiments.

FIG. 6 is a diagram showing an example of a quantitative data structure that maps personality archetypes to personality traits and Behavioral patterns (archetypes are universal models of distinct personality traits that play a role in influencing human behavior.) Said data structure maps certain combinations of personality traits (that are sometimes found together in archetypal characters) to implied Behavioral patterns.

### DETAILED DESCRIPTION

The following detailed description is of the best currently contemplated modes of carrying out the invention. The description is not to be taken in a limiting sense, but is made merely for the purpose of illustrating the general principles of the invention, since the scope of the invention is best defined by the appended claims.

According to some embodiments, there are provided herein computerized, AI-based methods and systems for generating a Story Development Environment (SDE). As detailed herein, the systems, method and user interface (UI) disclosed herein apply Role-Playing Language Agents. The following definitions are used in the descriptions

As used herein, the terms “CPLA” and “Character-Playing-Language-Agent” are interchangeable. The terms relate to a set of language technologies that are configured to role-play (simulate) a specific and distinctive character. In some embodiments, the language technologies may include, for example, but not limited to: Large Language Models (LLMs), that may be trained on behavioral models, retrained on specific data sets, Retrieval Augmented Generation (RAG), Knowledge Graphs (KG), Role-Playing Language Agents, context-engineering, etc., According to some embodiments, the CPLA may be configured to portray any character, in any story-specific environment, in any circumstances that may include (but not limited to) any character's history, prior relationships with other characters, psychological and behavioral traits, reasoning capabilities, etc. In some embodiments, a CPLA is story-aware in that it responds to specific story scenes in a scene-aware, timeline-aware and context aware way. In some embodiments, a CPLA may be conceptualized is as if it were an actor in a specific movie or show, playing a specific character while practicing the ‘Method’ acting technique (an acting technique where an actor aspires to fully inhabit the role, history, personality, inner motivations and emotions of the character).

As used herein, the terms “SDE” and “Story Development Environment” are interchangeable. The terms relate to a collaborative word processing environment adapted for story editing and development, where one or more of story characters may be role-played by CPLAs. In some embodiments, the SDE enables authors to define rich and believable characters as CPLAs, using a user interface that requires no psychological training or background. In some embodiments, the SDE provides methods of interaction between authors and role-played characters, including but not limited to an integrated messaging application. In some embodiments, the SDE may further include methods of integration of context generated by role-played characters, into the story document. In some embodiments, authors may choose to interact with these role-played characters at various points along the story timeline, or get them to textually-participate in specific story scenes and dialogues. According to some embodiments, interactions with CPLAs are story-aware, scene-aware, timeline-aware, in-character and/or in-context, in accordance with their history, motivations, inter-relationships, behavioral profile and/or tendencies.

As used herein, the term “Ensemble-character” relates to a story character in the SDE that is role-played by a CPLA. In some embodiments, authors may choose to interact with Ensemble-characters at various points within the story timeline, or get them to participate in specific story scenes and dialogues.

As used herein, the term “Character Inner-dialogue” relates to a stream of thoughts (aka stream of consciousness) that can cross the mind of an Ensemble-character in a specific point in a story timeline. According to some embodiments, it may be manifested in the SDE as a dialogue conducted in an integrated messaging/communication application, where the author provides an alter ego voice for the Ensemble-character, and the CPLA provides in-character responses. According to some embodiments, a Character's Inner-dialogue may become part of the story-specific information of the CPLA in role-playing the character, but may be regarded as out of the final production that is presented to an audience.

As used herein, the term “Characters' off-screen dialogue” relates to a dialogue between two Ensemble-characters that occurs out of the final production presented to an audience. However, it does become part of the story-specific information of the CPLAs in role-playing these Ensemble-characters.

As used herein, the term “Character Story-entry” relates to an in-story entry (for example, but not limited to—in the context of a screenplay—a dialogue entry or an action description) that is provided by an Ensemble-character, possibly, but not necessarily, in response to a request by an author.

As used herein, the term “Character-interaction” relates to a Character Inner-dialogue or a Characters' off-screen dialogue or a Character Story-entry, or any other interaction involving an Ensemble-character.

As used herein, the term “Extended-script” relates to a story plus all the elements of one or more Ensemble-characters, including all their Character-interactions.

As used herein, the term “Behavioral patterns” relates to various behavioral strategies a story character may deploy, or behavioral traps the character may fall into. Unlike psychological traits that may be general facets of personality (e.g. ‘intellectual’ or ‘open-minded’). Behavioral patterns refer to specific patterns of behavior that might be expected from a character with specific personality. In other words, personality plays a role in influencing human behavior, and once we know the personality traits of a character, we might be able to derive various strategies they might deploy and behavioral traps they might fall into.

The term “POV” Point Of View, relates to set of thoughts, feelings, beliefs, behaviors and/or responses generated in a specific character (having a specific behavioral patterns and/or specific history), in a certain context along a story progression. In some embodiments, the POV may include a simulated response of the ensemble character, wherein a response describes what the ensemble-character can think, feel, plan, act and/or say, in a certain context. The terms “POV”, “simulated response”, and “simulated POV” may be used interchangeably. The term “Context” refers to all story aspects that are potentially relevant to a specific character's POV at a certain point in time along the story progression. In some embodiments, the context may include such aspects as, but not limited to: filtered story history of the character including only scenes that are relevant to the ensemble-character at said point in time (that may be considered as the “present-time”) and until said point in time (that may be considered as the “past-times”) and/or future point in time, that may be available to the character (for example, via “flash-forward” mechanisms, or other suitable narrative devices), inner-dialogue(s) of the ensemble-character at and until said point in time (through which we can learn the character's state-of-mind and perception of past events, possible eventualities, and of other characters and their motivations in the story); personality and behavioral patterns of the ensemble-character, and the like, or any combinations thereof.

According to some embodiments, in the service of generality, the terms screenplay and story, and the terms playwright and author may be used interchangeably. However, for balancing specificity and generality, illustrated examples and diagrams focus on screenplays, while stories written in a non-standardized format may referred to when providing a wider context.

According to some embodiments, there are provided herein computerized systems and methods for providing a SDE (Story Development Environment). According to some embodiments, the systems and methods may be utilized by users, such as, authors, scriptwriters, screenwriters, playwrights, script-doctors, editors, directors and/or other users involved in the creative process.

According to some embodiments, in the SDE, various Ensemble-characters are automatically created as CPLAs, using a user interface that requires no psychological training or background. A user can then interact with Ensemble-characters as if they were real human actors that are playing the role of the respective characters. Also, the SDE includes methods of integration of context generated by Ensemble-characters, into the story document. Interactions with CPLAs are story-aware, scene-aware, timeline-aware, in-character, in-context, in accordance with, for example, their history, motivations, inter-relationships, behavioral profile and tendencies. In some embodiments, the author may retain full control over each and every detail of the screenplay, and can stir and direct the Ensemble-characters and the plot towards any twist and turn and any climax and conclusion. In some embodiments, each Ensemble-character has its point of view (POV), wherein the point of view is contextual. In some embodiments, the CPLA enables the POV context management of the ensemble characters. In some embodiments, the contextual POV may be in relation to a specific scene, a specific point of time in the story, etc.

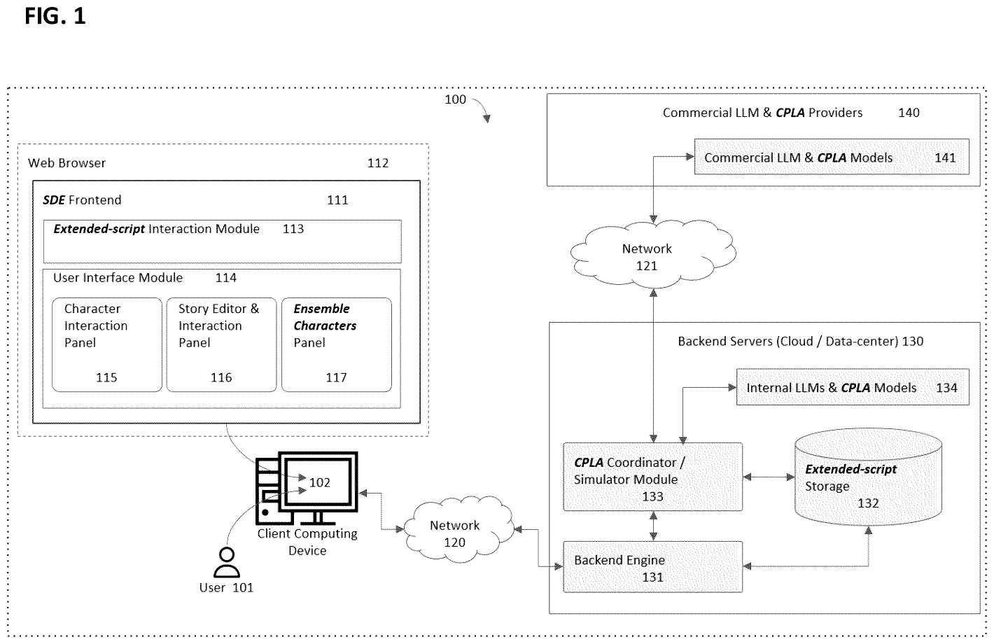

Referring to FIG. 1, system 100 may include various modules and data structures that may be incorporated in hardware, software, firmware, or in any combination of the foregoing. The hardware, software, firmware, or combination thereof may be implemented locally in a single location (i.e. on a computational device, such as, PC, laptop, tablet, mobile device), or in part using computer processing power that is in communication with other computer or data communications networks. In some embodiments, the components of the system may be functionally associated. In some embodiments, at least some of the components of the system may be located in remote locations (for example, on a cloud server). In some embodiments, the system is a distributed system, where portions of the system (e.g., a backend engine and the frontend are located on separate computing devices). In some embodiments, the system includes one or more processors, housed or located in a single computation device (e.g., having or executing both a backend engine and frontend modules).

In the Example shown in FIG. 1, distributed system 100 may be organized as follows: A User 101 operates/interacts with an SDE Frontend 111, which may run on a Client Computing Device 102. In some embodiments, Client Computing Device 102 may include an operating system, one or more processing units, one or more storage units, one or more network interfaces, and user interface devices such as a keyboard and/or a mouse and one or more monitors. The SDE Frontend 111 may be executed either directly on the Client Computing Device 102 operating system, or within an intermediary environment (e.g., a web browser) 112. In some embodiments, SDE Frontend 111 may include an Extended-script Interaction Module 113, and a User Interface module 114.

In some embodiments, an Extended-script Interaction Module 113 may be configured to manage the SDE Frontend 111 workflows and integration with the User Interface module 114 operating logic. Also, it may provide a networking and operating interface with Backend servers 130, through a network 120 and optional Backend Engine 131.

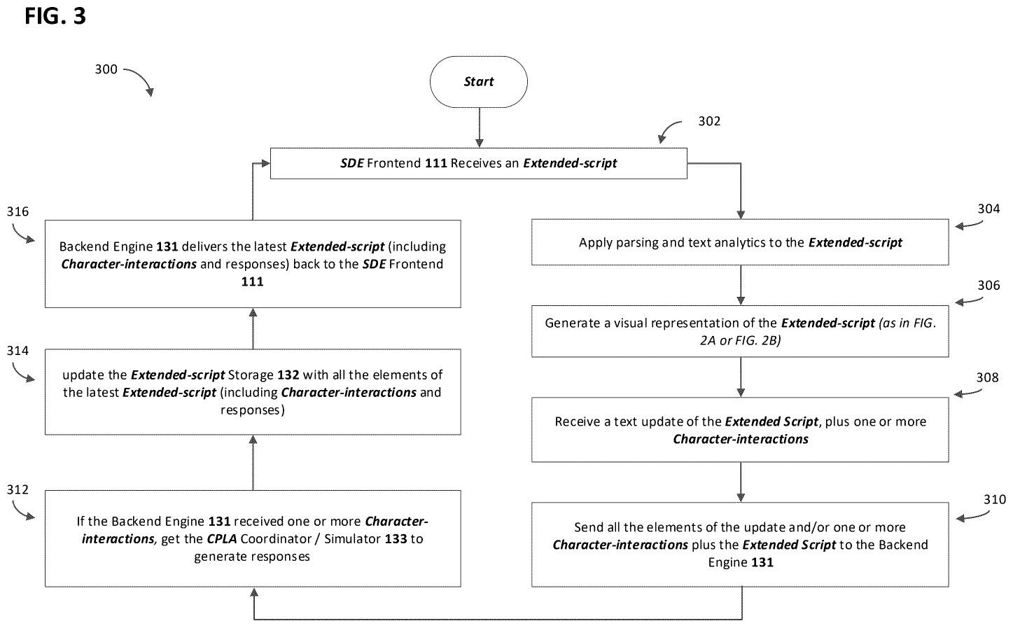

According to some embodiments, User Interface module 114 may include one or more panels, including Character Interaction Panel 115, Story Editor and Interaction Panel 116, Ensemble Characters Panel 117, or any combinations thereof. Such panels are further detailed and exemplified in FIG. 3A-FIG. 3E, below).

According to some embodiments, Backend Servers 130 may be shared computing resources which may include one or more server computers (e.g., a single on premises server or a remote server), supercomputers, mainframes, computers connected in a peer-to-peer or mesh network, combinations thereof, or other computing resources that may be shared through the Network 120. In some embodiments, Backend Servers 130 may include a Backend Engine 131, a CPLA Coordinator/Simulator Module 133, an Extended-script Storage 132, and Internal LLMs and CPLA Models 134.

According to some embodiments, multiple SDE Frontends 111, Client Computing Devices 102, and/or Users 101 may be simultaneously engaging the Backend Servers 130, while accessing different Extended-scripts and role-playing different Ensemble Characters. In some embodiments, multiple SDE Frontends 111, can be simultaneously working on different Extended-scripts on a single Client Computing Devices 102 (e.g. from different Web Browsers 112). In some embodiments, multiple SDE Frontends 111, can be working simultaneously on the same Extended-script in a multi-user simultaneous editing fashion consistent with conventional industry practices.

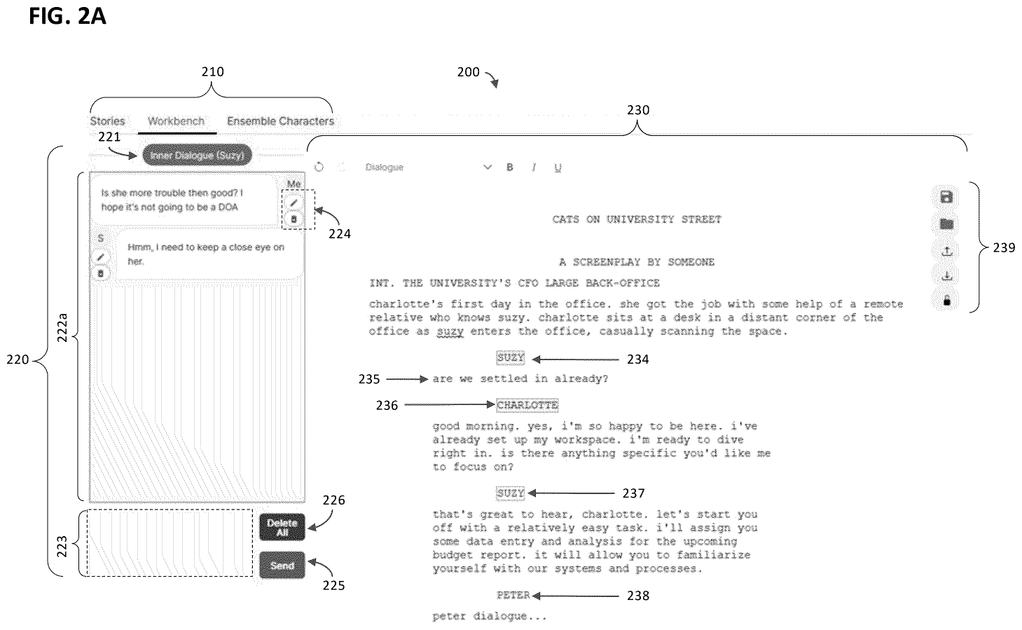

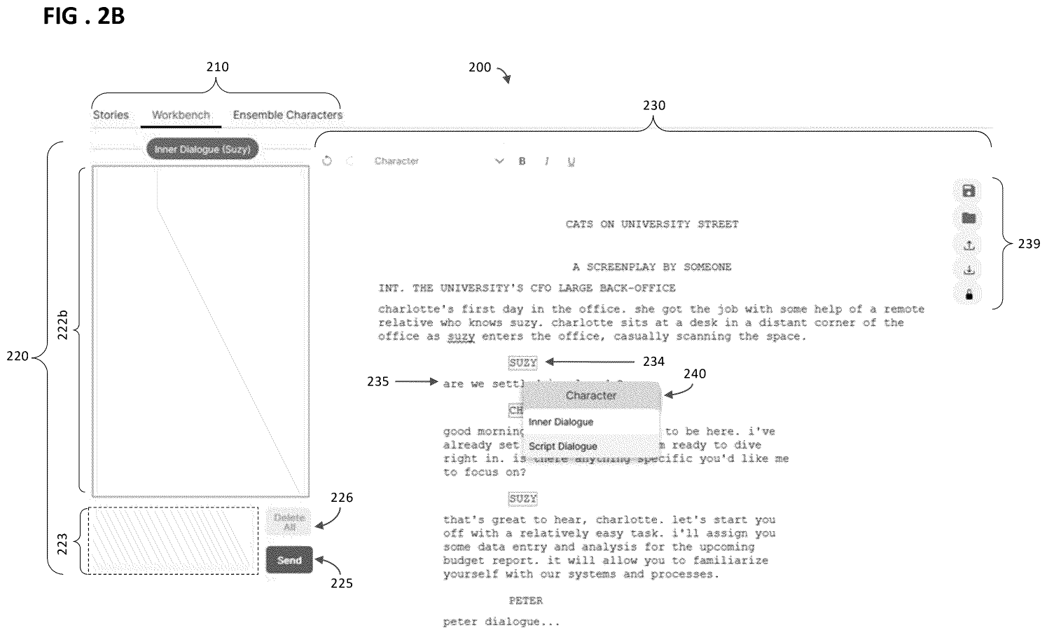

According to some embodiments, Backend Engine 131, may be a web server or similar technology, providing a gateway to the shared computing resources of the Backend Servers 130 to the multiple Client Computing Devices 102, and SDE Frontends 111 that may be sending requests and expecting responses (as expanded on and exemplified in FIG. 2A and FIG. 2B). Thus, Backend Servers 130 may be able to simultaneously handle a practically unlimited number of SDE Frontends 111, Client Computing Devices 102, and Users 101.

According to some embodiments, when applicable, Backend Engine 131 may respond directly to requests of an SDE Frontend 111 by retrieving information from the Extended-script Storage 132, and sending it back to the requester. In other cases, it may forward the request to a CPLA Coordinator/Simulator Module 133, and relay the response back to the requester.

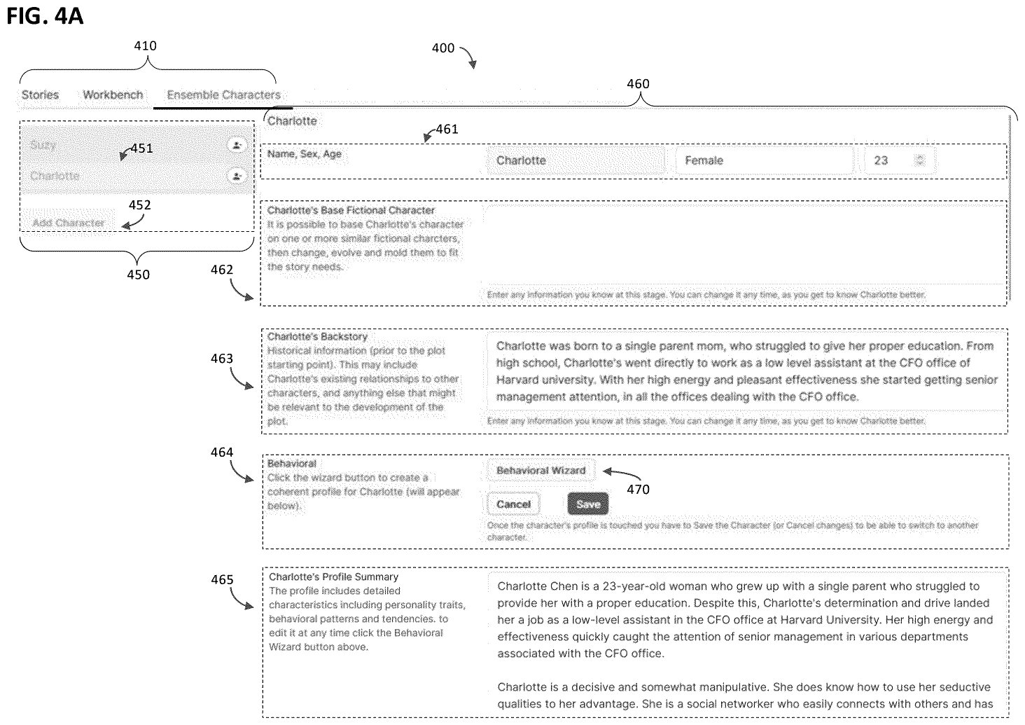

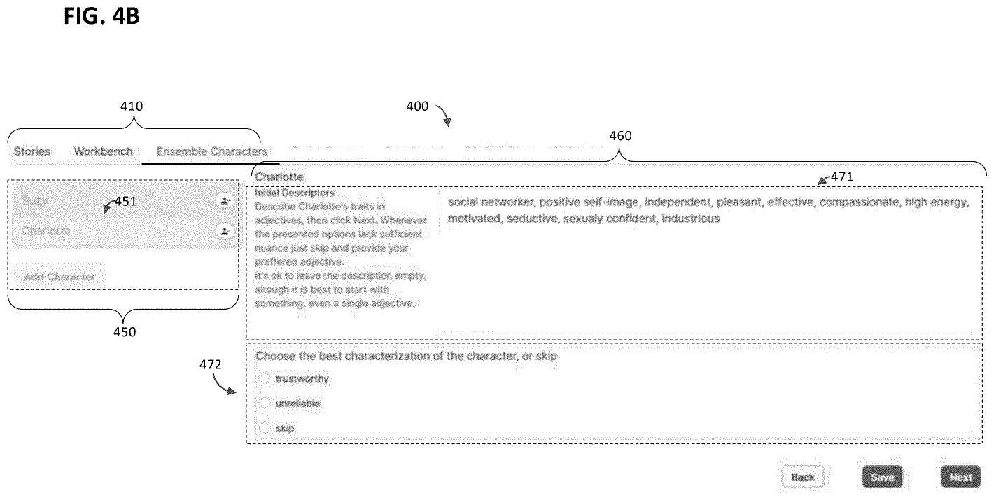

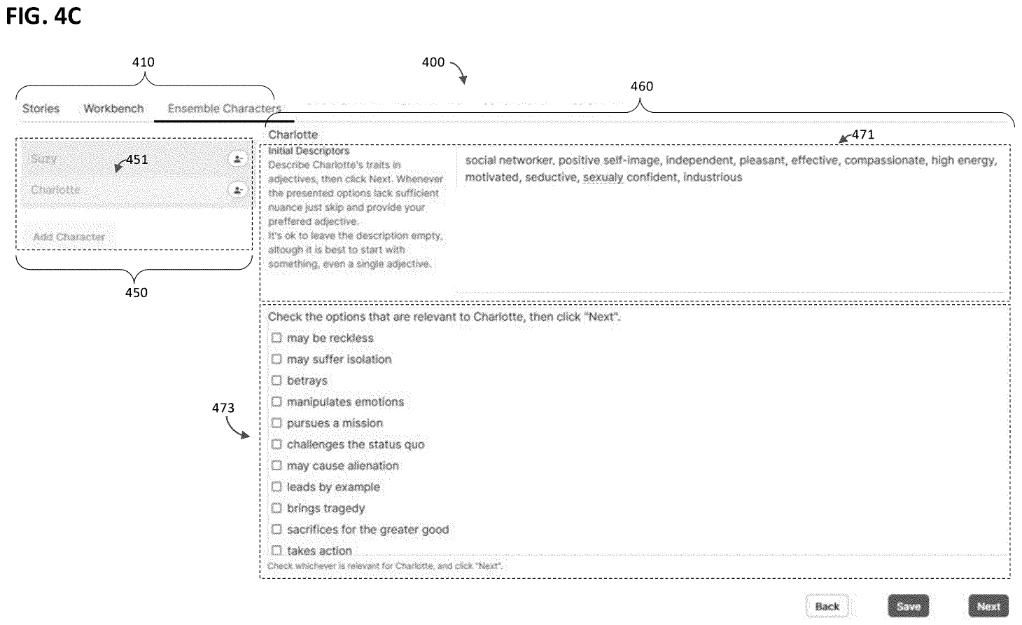

According to some embodiments, the CPLA Coordinator/Simulator Module 133 may provide orchestration of multiple methods and information pieces to create a simulation (role-play) of any specific Ensemble Character in any specific story situation. In some embodiments, a possible set of technologies and information that may be utilized to simulate any specific Ensemble Character in any specific story situation may include, but not limited to: language technologies (e.g., but not limited to, Large Language Models trained on behavioral models, retrained on specific data sets, various prompt-engineering methods, and the like), plus story-specific information, plus character-specific information (that may include, but not limited to, the character's history, prior relationships with other characters, psychological and behavioral traits, reasoning capabilities), etc. Together, these technologies and information pieces may be used to textually-role-play a story-character in general, and in specific story scenes, in a context aware way (e.g., like a human actor practicing the ‘Method’ acting technique (an acting technique where an actor aspires to fully inhabit the role, history, personality, inner motivations and emotions of the character)). It should be noted that an Ensemble Character may be configured and adapted in the SDE Frontend 111, by the user, to portray any character, in any story-specific environment, in any circumstances that may include, but not limited to, any character's history, prior relationships with other characters, psychological and behavioral traits, reasoning capabilities, etc. (as illustrated in FIG. 4A through FIG. 4C, below).

In some embodiments, the Extended-script Storage 132 may be one or more databases or data repositories where Extended-scripts may be stored (this may include the story itself, plus all the elements of one or more Ensemble-characters, including all their Character-interactions.) The Extended-script Storage 132 may be accessed by the Backend Engine 131 and the CPLA Coordinator/Simulator Module 133 to retrieve story-specific information, plus character-specific information.

According to some embodiments, to coordinate the multiple technologies and information pieces that may be required to perform a simulation (role-play) of any specific Ensemble Character in any specific story situation, the CPLA Coordinator/Simulator Module 133 may access Internal LLMs and CPLA Models 134. It may also access, through Network 121, external commercial providers (Commercial LLM & CPLA 140) that may publish APIs (Application Programming Interfaces) to LLM & CPLA Models 141.

Reference is now made to FIG. 2A and FIG. 2B, illustrating a screenplay layout view with additional features, presented in the user interface of a platform adapted to perform the workflows of a system 100, according to some embodiments. In FIG. 2A and 2B, an example user interface 200, which may be a partial embodiment of User Interface Module 114, may include editing panel 230, sub-system selection panel 210, and character inner-dialogue panel 220.

According to some embodiments, as shown in FIG. 2A and FIG. 2B, sub-system selection panel 210, which may be a partial embodiment of the Extended-script Interaction Module 113, may be used to enable a user to switch between different functional aspects of the user interface 200 and 400 (shown in FIGS. 4A-C). The functional aspect shown in both figures is of “workbench” which may include the editing panel 230 and character inner-dialogue panel 220.

According to some embodiments, as shown in FIG. 2A and FIG. 2B, editing panel 230, which may be an embodiment of Story Editor and Interaction Panel 116, is used to present a textual representation of a screenplay. A user can add, edit, delete, and/or view the screenplay in an editor environment adhering to standard screenplay formatting rules. A script adheres to standardized format, where specific sections of it may be formatted (e.g., capitalization, indentation from left margin, etc.) in ways that distinguish their role in a presentation of the story. For example, SUZY 234, is formatted as a character name, which indicates that the following block of text 235 (formatted as a dialogue) is to be uttered by the actor playing the character SUZY. It should be noted that the illustrated embodiment of a standard-formatted screenplay within the editing panel 230 is for balancing specificity and generality; while stories written in a non-standardized format may well be developed in an SDE platform.

According to some embodiments, as shown in FIG. 2A and FIG. 2B, character inner-dialogue panel (also referred to as character interaction panel) 220, which may be an embodiment of Character Interaction Panel 115, is used to present textual dialogues between an Ensemble-character (managed by the CPLA Coordinator/Simulator Module 133) and a User 101.

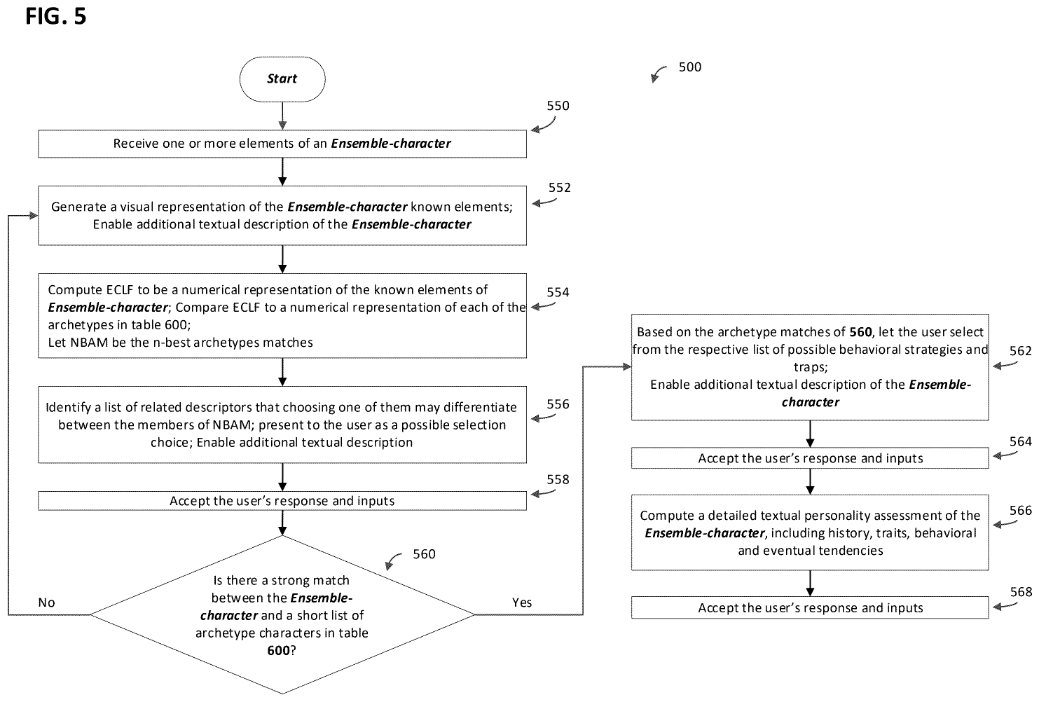

According to some embodiments, as shown in FIG. 2A, the editing panel 230 may be configured to display an example screenplay snapshot that includes four character-name lines: SUZY 234, CHARLOTTE 236, SUZY 237 and PETER 238. The character names include visual markings that indicate various features. In this example, both instances of SUZY (234 and 237) and the single instance of CHARLOTTE (236) have an outer border frame, which indicates that Suzy and Charlotte are Ensemble Characters. It should be noted that Ensemble-characters are defined as such in a separate process, as explained in FIG. 4A-4C and FIG. 5 below. In contrast to the Ensemble-characters SUZY and CHARLOTTE, the character name PETER 238 has no outer border frame, which indicates that Peter is a regular character that is not role-played by a CPLA. Also, the first instance of SUZY (234) and the single instance of CHARLOTTE (236) may be color coded (e.g. colored light green), which indicates that these specific instances and screenplay points have Character Inner-dialogue attached to them (associated therewith).

In the example shown in FIG. 2A, the inner-dialogue 222a is attached to the Ensemble-character name SUZY at the screenplay point 234. According to standard formatting rules of screenplays, the following script dialogue 235 is uttered by the character SUZY. This screenplay setup may be interpreted as the inner-dialogue 222a is the stream of thoughts that cross Suzy's mind just prior to her uttering the script dialogue 235.

According to some embodiments, a full screenplay may include a plurality of separate Character Inner-dialogues for each Ensemble-character, each of them may be attached to a different screenplay point. All the interactions in a specific point (e.g., a dialogue containing a few back and forth messages) are part of a single inner-dialogue and stream of thoughts.

According to some embodiments, it should be appreciated that unlike script-dialogues (e.g., script dialogue 235), that are meant to be uttered by their respective actors, a Character Inner-dialogue is not meant to be a direct part of a final production that is presented to an audience. However, it does become a crucial part of the story-specific information of the CPLA when role-playing an Ensemble-character at the respective screenplay point. In other words, a possible treatment by the SDE is as if an Ensemble-character's Inner-dialogue is the stream of thoughts that cross said character's mind just prior to the next content point in the story. For example, if at a certain point in the screenplay, an inner-dialogue of an Ensemble-character includes references to some specific emotions felt by the character (some of which were generated by the respective CPLA of the Ensemble-character, and some edited into the inner-dialogue by the user), these emotions will become part of the story-specific information of the CPLA when role-playing the Ensemble-character at the respective screenplay point. Consequently, it might influence the CPLA to include expressions of these emotions when prompted for a response in later points.

Shown in FIG. 2B is an empty inner-dialogue 222b, which in terms of the script writing process, reflects an earlier snapshot of the inner-dialogue 222a illustrated in FIG. 2A. One way for the inner-dialogue messaging to start is when a User 101 selects (e.g., right-clicks) an Ensemble-character name in panel 230, as exemplified in the screenplay context point of SUZY 234. A context sensitive menu 240 opens up, and presents a list of relevant options. The options are ‘Inner Dialogue’ and ‘Script Dialogue’. When the user selects the option ‘Inner Dialogue’ the SDE may upload the latest interaction that is stored in the Extended-script Storage 132 that is attached to the context point of SUZY 234. In the example of inner-dialogue 222b the latest interaction that is attached to the screenplay context point of SUZY 234 is empty. Next, the user may initiate a conversation in the inner-dialogue panel 220 with the Ensemble-character

SUZY which is attached to script point 234. The user may edit a new message in the new message editor panel 223, then click the ‘Send’ button 225. This initiates a process (explained in details in the flowchart in FIG. 3) where a CPLA will role play the Ensemble-character SUZY, at the respective screenplay point, to respond in-character and in-context. The reply will appear in inner-dialogue panel 220. Such a message and response example is seen in inner-dialogue 222a illustrated in FIG. 2A—where the first message was authored by the user and the second message is the Ensemble-character SUZY response.

According to some embodiments, a User 101 may edit and/or delete and/or scroll to, and view every single message within every inner-dialogue (including, the author's messages and Ensemble-character's responses), using standard controls, e.g., such as those common in chat applications. As illustrated in FIG. 2A and FIG. 2B such controls may include, for example: 223 (author a new message), 225 (send a newly authored message), 226 (delete all the current inner-dialogue) and 224 (edit or delete an existing message).

According to some embodiments, when a user 101 selects (e.g. right-clicks) an Ensemble-character name, such as SUZY 234, and the context sensitive menu 240 appears, they may select the ‘Script Dialogue’ option, or some other Character-interaction option not illustrated here. The treatment of these options may be similar to the ‘Inner Dialogue’ option, as they may involve the SDE uploading the latest elements of the Extended-script stored in the Extended-script Storage 132, and having one or more CPLAs to role play the relevant Ensemble-characters in the respective screenplay point, then respond in-character and in-context to whatever script situation or hypothetical situation posed to them. Their replies may appear in appropriate panels enabling a User 101 to edit and/or delete and/or scroll to, and view every single reply within every Character-interaction.

According to some embodiments, as important feature of a CPLA role playing an Ensemble-characters in a specific screenplay point (when activated or stimulated to do so, regardless of the type of Character-interaction or stimuli), is the data available to it to generate its response based thereon. These data are a subset of the Extended-script. It may include all the Character-interactions said Ensemble-character is involved in, plus story content (e.g. scenes, events, etc.) that is available to the respective story character until the respective specific screenplay point, plus the Ensemble-character's own backstory as it provided in their profiles. Examples of data that may not be available to said CPLA when generating its response are: a) all Character Inner-dialogues of other Ensemble-characters; b) data about story scenes that the respective story character is not part of; c) data about scenes that the respective story character is not supposed to be aware of at the respective specific screenplay point (e.g. in the story's future at that point in the story timeline).

Reference is made to FIG. 3, showing a flowchart of example operations 300, that can be performed in a platform adapted to provide an SDE, in a use case where Ensemble-characters are already defined in the SDE. A possible user interface of such a platform is illustrated, for example, in FIG. 2A and FIG. 2B.

As shown in FIG. 3, at step 302, the SDE Frontend 111 receives an Extended-script either by a User 101 starting a new script (on a blank editing area), or via the Backend Engine 131, when a User 101 uploads an existing Extended-script from the Extended-script Storage 132. At step 304, the Extended-script is parsed and its text is analyzed to identify different sections within the story (e.g. character names, locations, scenes and dialogue pieces). In the case of a screenplay, the standard formatting and editor tags may be used to identify these sections. In the case of a free format story, this may be facilitated using Natural Language Processing (NLP) technologies, such as Name Entity Recognition (NER), LLMs, etc. At step 306, the result of 304 is used to generate a visual representation of the Extended-script in the SDE Frontend 111, while providing additional formatting of certain text sections to indicate their SDE status. For example, as illustrated in FIG. 2A or FIG. 2B, all instances of SUZY (234 and 237), and the single instance of CHARLOTTE (236) have an outer border frame, to indicate that both are Ensemble Characters.

At step 308, the SDE Frontend 111 receives one or more updates to the Extended-script. This may be a text update to the script itself, or one or more Character-interactions, or both. In this context, the simplest example for a Character-interaction is when a User 101 engages in a conversation with an Ensemble-character via the inner-dialogue panel 220 (described above in FIG. 2A and FIG. 2B). Another example is when a User 101 selects the ‘Script Dialogue’ option in the context sensitive menu 240 (FIG. 2B). These updates initiate a process that spans steps 310, 312 and 314. At step 310, all the elements of the update and one or more Character-interactions plus the Extended Script are sent to the Backend Engine 131 via the Network 120.

At step 312, if the Backend Engine 131 receives only text updates for the Extended-script it can simply update the Extended-script Storage module 132. However, if it receives one or more Character-interactions, it may forward them to the CPLA Coordinator/Simulator 133, which may collect all the information that is relevant to generating the one or more Ensemble-character responses. This may include, but not limited to, the information about the personalities involved, their prior histories, their prior relationships, their psychological and worldly motivations, their behavioral tendencies, their point of view of the events told in the story, and that according to the plot, they are aware of. Some of the information is stored as-is in the Extended-script Storage 132, whereas some may be inferred from the various information pieces received and stored in the Extended-script Storage 132. This may be achieved via well-established Natural Language Processing (NLP) technologies such as (but not limited to) Name Entity Recognition (NER), LLMs, etc. After the CPLA Coordinator/Simulator 133 collects and infers the data it needs, it may use Internal LLMs and CPLA Models 134 and/or Commercial LLM and CPLA Providers 140 to simulate responses for the specific requested Character-interactions. At step 314, the Backend Engine 131 updates the Extended-script Storage 132 with all the elements of the latest Extended-script, including Character-interactions and responses. At step 316, Backend Engine 131 delivers the latest Extended-script (including Character-interactions and responses) back to the SDE Frontend 111, where the SDE Frontend 111 awaits one or more new state transitions.

Reference is now made to FIG. 4A, illustrating various aspects of an Ensemble-character creation layout view with additional features, presented in the user interface of a platform adapted to perform the workflows of a system 100. An example user interface 400, which may be a partial embodiment of User Interface Module 114, includes a sub-system selection panel 410, which may be a partial embodiment of the Extended-script Interaction Module 113, is used to enable a user to switch between different functional aspects of the user interfaces 200 and 400. The functional aspect shown is of “Ensemble-characters” which may include a character list panel 450, and character description panel 460 (also referred to herein as ensemble character panel).

According to some embodiments, character list panel 450 may include a list of existing Ensemble-characters (the example of FIG. 4A illustrates Suzy and Charlotte as Ensemble-characters). A button 452 ‘Add Character’ may initiate a process of defining a new Ensemble-character. The name Charlotte 451 is illustrated as selected in the character list panel 450, which implies that the character description panel 460 is populated with the latest version of the profile of the Ensemble-character Charlotte, and where fine-tuning of the portrayal may continue. Panel 460 may include one or more fields of various formats (such as free text, buttons, option-selection, etc.), plus one or more wizards that may utilize psycholinguistic models to enable a user to portray and define rich and believable characters.

In some embodiments, section 461 enables the author to describe information such as name, sex and age of the Ensemble-character. Section 462, may enable an author to reference one or more known fictional characters on which the Ensemble-character's personality may be based on. This may enable the SDE to infer initial personality traits from publicly available texts and utterances attributed to that fictional character (e.g. from screenplays the fictional character is a character in). Then the author may fine-tune and mold the Ensemble-character's personality to fit the story needs. In the illustrated example 462 no fictional character is mentioned. Section 463 may include the Ensemble-character's backstory.

In some embodiments, section 464 includes a ‘Behavioral Wizard’ button 470, which is the launch button of a wizard that may utilize psycholinguistic models to enable a user to define rich and believable characters, with no psychological training or background. Various embodiments of such a wizard are illustrated and described below in FIG. 4B and FIG. 4C. Section 465 may be a textual summary of the profiling information provided about the Ensemble-character. This may include, but not limited to, prior history, relationships, psychological and worldly motivations and Behavioral patterns. The summary may be provided by a wizard (such as the one that may be started by a click on ‘Behavioral Wizard’ button 470), that binds together all the information provided about the Ensemble-character into a coherent and conclusive profile.

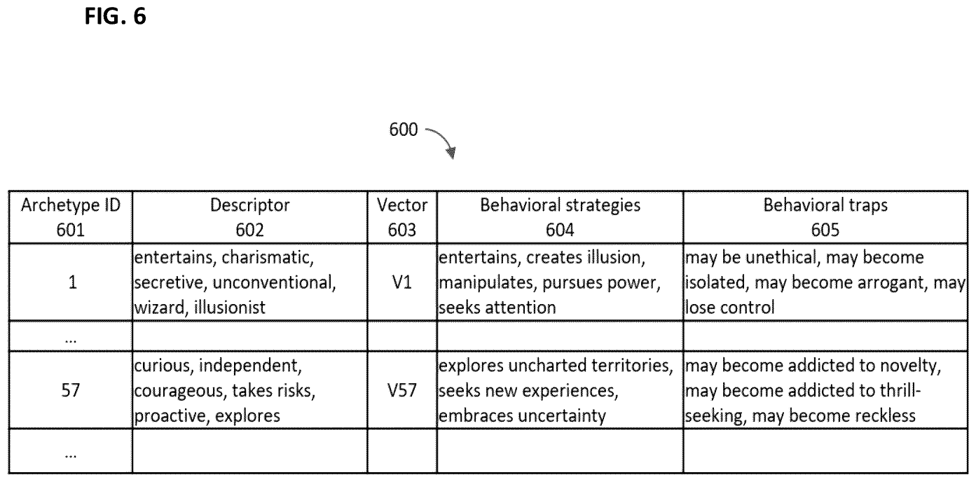

Reference is made to FIG. 4B and FIG. 4C, illustrating embodiments of a wizard that may utilize psycholinguistic models to enable a user to portray and define rich and believable characters, with no requirement for psychological training or background (such as the one that may be started by a click on ‘Behavioral Wizard’ button 470). Said wizard may feature Initial Descriptors 471 where at any time while the wizard is active a user may add, change or delete various descriptors based on their evolving vision of the character's traits. Alternatively, the wizard may provide a differentiating question (e.g. 472) to be answered by a user. It should be appreciated that an important feature of said wizard is the dynamic nature of the differentiating question to be posed to a user. It is computed dynamically by the wizard based on an evolving internal psychological model the wizard generates of the specific Ensemble-character being portrayed. Once said wizard collects enough descriptive data about the Ensemble-character to suggest possible Behavioral patterns, it may switch to a next phase as illustrated in FIG. 4C. A possible condition for ‘enough descriptive data’ is described, for example, in FIG. 4C, FIG. 5 and FIG. 6.

Referencing FIG. 4C, section 473 illustrates a list of possible Behavioral patterns that may be consistent with an evolving psychological model said wizard may generate for the Ensemble-character being portrayed. In the illustrated example in Section 473, a behavioral strategy might be ‘challenge the status quo’, while a behavioral trap might be ‘may cause alienation’. A user may be able to select which of these Behavioral patterns do indeed fit their vision of the character.

According to some embodiments, once a user selects the Behavioral patterns and eventualities that fit their vision of the Ensemble-character being portrayed, they may exit said wizard and get back to a textual summary of the Ensemble-character. This may include, for example, but not limited to, prior history, relationships, psychological and worldly motivations and Behavioral patterns.

Reference is now made to FIG. 5, which shows a flowchart of example operations 500 that can be performed in a platform adapted to provide an SDE, in a use case where the user may define or fine tune an Ensemble-character, according to some embodiments. A possible user interface of such a platform is illustrated in FIG. 4A, FIG. 4B and FIG. 4C.

As shown in FIG. 5, at step 550, one or more elements of an Ensemble-character are received either by a User starting a new (empty) character portrayal via an ‘Add Character’ button (e.g. 452), or via the Backend Engine uploading an existing Ensemble-character definition from the Extended-script Storage. At step 552, a visual representation of the Ensemble-character known elements is generated (as illustrated, for example, in FIG. 4A (400)), and enables the user to edit any existing elements of the character portrayal. At step 554, ECLF (a mathematical representation of the elements of a character) is computed for the current Ensemble-character being portrayed; This may be done using, for example, language vector embeddings-in which case ECLF is a vector or numbers (but not necessarily so). In the context of the SDE, language vector embeddings computation may be provided via the Network 120 and the Backend Engine. It should be noted that as detailed below in FIG. 6, below table 600 contains an ECLF representation for each of archetypal character models (vectors 603), which may be computed once, when constructing the table 600. This enables the comparison of the ECLF values of the current Ensemble-character being portrayed and each of the archetypal character models listed in table 600, resulting in a measure of similarity between each of them.

According to some embodiments, at the conclusion of each iterative step 554, process 500 holds an updated ranking of the archetypes in table 600 matches to the current Ensemble-character being portrayed. Each iteration of step 554 concludes by singling out the sub list NBAM, the list of n-best archetype matches (where n may be defined by a configuration component). Generally, in the first iterations of step 554, the difference in matches may be small—such that many archetypes in table 600 may be considered to be somewhat similar to the current Ensemble-character being portrayed. In the next iterative step 556 it may look to differentiate between these many somewhat similar archetypes, and pinpoint those that are the most similar.

At step 556, the SDE can compute/identify a list of related descriptors that choosing one of them may differentiate between the members of NBAM. The related descriptors are dynamically computed to exploit the continuum of differences between the aggregate descriptors of each archetypal model in table 600 (in other words, it is possible to compute a match level between each and every archetypal model in table 600 and then find descriptors that best explain each duo differences). Computing such a differentiating question, presenting it to the user for selection (e.g. in 472), and letting the user choose a descriptor enables the process 500 to re-rank the n-best matches and get to a more nuanced portrayal of the Ensemble-character.

At step 558, the user's response and inputs are accepted/inputted. At step 560, once there is a strong match (“Yes”) between the Ensemble-character being portrayed and a short list of archetypal characters in table 600 (in other words, the descriptive data collected about the Ensemble-character being portrayed enables to pinpoint a short list of sufficiently similar archetypes-explained in more details in FIG. 6), the process switches to step 562, otherwise (“No”) it goes back to 552.

At steps 562 and 564, based on the accumulated information about the Ensemble-character—a list of possible Behavioral patterns (as illustrated, for example, in section 473 of FIG. 4C) may be computed using table 600 (explained in more details in FIG. 6). In the illustrated example in Section 473, a behavioral strategy might be ‘challenge the status quo’, while a behavioral trap might be ‘may cause alienation’. A user may be able to select which of these Behavioral patterns do indeed fit their vision of the character.

At step 566, based on the accumulated information about the Ensemble-character, it is possible to dynamically compute personality assessment and provide a detailed textual summary of the Ensemble-character that may include, but not limited to, prior history, relationships, psychological and worldly motivations, behavioral tendencies and patterns, and possible eventualities stemming from such patterns. At step 568 the user may edit anything and/or everything in the character portrayal and conclude its definition. Reference is now made to FIG. 6, illustrating an example of a quantitative data structure, a data table 600, representing a mapping between various personality traits and their behavioral tendencies. Each row represents a psychologically coherent combination of traits that might be considered archetypal by storytellers (aka personality types, styles, models, etc.). Column 601 is an archetype ID, column 602 contains a unique combination of personality descriptors. Column 603 contains a unique vector representation of the personality descriptors in column 602. This may be done (but not necessarily so), using, for example, language vector embeddings, or other suitable tools. Column 604 and 605 contain potential behavioral patterns of an archetypal character with the respective unique combination of personality descriptors. Column 604 identifies certain behavioral strategies used by someone with the respective combination of personality descriptors when faced with challenges. Column 605 identifies certain behavioral traps that someone with the respective combination of personality descriptions might fall into.

According to some embodiments, table 600 in FIG. 6, does not represent specific characters (fictional or real). Rather, it represents personality archetypes. The identification of these archetypes and mappings between their personality traits and their behavioral tendencies may be provided by expert psychologists, authors and screenwriters. For example, archetype ID 57 presents a typical archetypal combination that may be named the ‘Explorer’. The Explorer is inherently curious, independent, courageous, takes risks, and proactively explores. As a matter of practical consequence, when faced with challenges, the explorer might deploy his/hers typical strategies: exploration of uncharted territories, seeking new experiences, embracing uncertainty; Also, s/he might fall into the common traps of: becoming addicted to novelty or thrill-seeking, or, may become reckless. Another example might be of archetype ID 1 which presents a typical archetypal combination that may be named the ‘Magician’.

According to some embodiments, data of Table 600 may be used by the Behavioral Wizard 470 and process 500, to help users in portraying rich and believable Ensemble-characters, fusing complex combinations of archetypes. For example, the Behavioral Wizard 470 may help a user identify an Ensemble-character that is some combination of an Explorer (archetype ID 57) and a Magician (archetype ID 1) with some specific life story, a certain psychological disorder, career path or even criminal tendency. Once the process of portraying an Ensemble-character has been finalized, table 600 may not be needed for the operation of the respective CPLA.

According to some embodiments, each of the disclosed modules is a computational module having at least a processor and/or a memory components. According to some embodiments, one or more of the modules (e.g., backend engine, CPLA coordinator module, the extended-script storage, etc.) are computational modules having or being associated with at least one processing unit and/or a memory unit.

According to some embodiments, there is provided a computer-implemented method for simulating and editing an extended-script comprising a plurality of characters, the method includes:
receiving, via a user interface executed on a client computing device, an extended-script including a plurality of scenes and character interactions;
parsing, by a frontend module, the extended-script to identify characters, dialogues, and screenplay elements;
associating at least one ensemble-character with corresponding character-specific information including a backstory, behavioral tendencies, and relationships;
transmitting the extended-script and character-specific information to a backend engine, for example, via a network;
generating, by a coordinator module executing on the backend engine, a role-play simulation of the ensemble-character in a specific story context using one or more large language models and contextual data;
returning a simulated response of the ensemble-character to the client computing device; and
displaying, in the user interface, a dynamic inner-dialogue panel presenting the simulated response in context with the extended-script.

According to some embodiments, parsing the extended-script includes, but not limited to, applying natural language processing models, including, for example, named entity recognition (NER) to identify characters and dialogues.

According to some embodiments, the method may further include enabling multi-user simultaneous editing of the extended-script via the user interface.

According to some embodiments, the coordinator module may dynamically retrieve relevant portions of the extended-script from the extended-script storage corresponding only to the context relevant to the ensemble-character at a specific point in the screenplay timeline.

According to some embodiments, the method may further include generating, via a behavioral wizard, psycholinguistic models to assist a user in defining personality and behavioral models of ensemble-characters, using combinations of descriptive text and/or mixture of archetypes.

According to some embodiments, the user interface may include a selectable context-sensitive menu enabling a user to initiate inner-dialogue or script-dialogue interactions with an ensemble-character.

According to some embodiments, the method may facilitate interaction of a plurality of users.

According to some embodiments, there is provided a computer-implemented method for context-aware character simulation in a collaborative script development environment, the method includes:
executing, by a client computing device, a specialized user interface comprising a screenplay editing panel and an interactive inner-dialogue panel configured to simultaneously display screenplay text and simulated character responses;
parsing, by a frontend module of the client computing device, an extended-script into structured screenplay elements including scene identifiers, dialogue segments, and character names using natural language processing techniques;
identifying, by the frontend module, one or more ensemble-characters within the extended-script and associating each ensemble-character with corresponding metadata including a backstory, behavioral archetypes, and timeline-aware story context;
transmitting, (for example, via a network interface), only a timeline-constrained subset of the extended-script relevant to a current ensemble-character interaction to a backend engine.
generating, by a backend coordinator module executing on the backend engine, a role-play response of the ensemble-character by selectively invoking one or more large language models restricted to the timeline-constrained subset and behavioral archetype embeddings;
returning the generated role-play response to the client computing device; and
updating, in real time, the inner-dialogue panel of the user interface to display a conversation thread between a user and the simulated ensemble-character while maintaining synchronization with the screenplay editing panel.

According to some embodiments, there is provided a distributed computing system for collaborative extended-script editing and timeline-aware character simulation, the system includes:
a client computing device including a processor, a memory storing executable instructions and a user interface module configured to:
   display a screenplay editing panel with standardized screenplay formatting;
   display an inner-dialogue panel presenting simulated responses from ensemble-characters; and
   enable user selection of a character name to initiate timeline-aware simulation;
a backend engine communicatively coupled to the client computing device, the backend engine includes:
   a simulation coordinator module configured to orchestrate simulation requests;
   a psycholinguistic archetype module configured to retrieve and compute behavioral tendencies for ensemble-characters using vector embeddings;
   an extended-script storage configured to maintain story-specific metadata and dynamically retrieve only timeline-relevant portions of the extended-script; and
   one or more large language models configured to generate ensemble-character responses constrained by story context and archetype data;
wherein the backend engine is further configured to return to the client computing device an in-character simulation response optimized for the timeline-aware screenplay point, thereby reducing unnecessary computation and improving simulation consistency for multi-user environments.

According to some embodiments, there is provided a system for creating, editing, and simulating extended-scripts, the system includes a backend engine communicatively coupled to a client computing device, the backend engine includes:
a simulator module configured to coordinate story-specific and character-specific data;
one or more large language models adapted to generate character responses; and
an extended-script storage configured to persistently store updated scripts and character interactions;
wherein the backend engine is configured to return to the client computing device, in-character responses of an ensemble-character at a specific story point for display in the inner-dialogue panel.

According to some embodiments, the client computing device includes a processor, a memory, and a user interface module configured to:
receive an extended-script including a plurality of characters and dialogues;
display a story editor panel and an inner-dialogue panel; and
transmit extended-script updates and character-interactions to the backend engine.

According to some embodiments, the backend engine may further include a behavioral model coordinator configured to retrieve archetype-based behavioral tendencies for ensemble-character generation.

According to some embodiments, the user interface module includes multiple panels comprising a story editor, a character interaction panel, and an ensemble-character management panel.

According to some embodiments, multiple client computing devices may be simultaneously coupled to the backend engine for collaborative editing of the same extended-script.

According to some embodiments, there is provided a non-transitory computer-readable medium storing instructions that, when executed by one or more processors, cause the processors to:
render, on a client device, a screenplay editing panel synchronized with an inner-dialogue panel in a specialized user interface;
parse an extended-script using natural language processing models to identify screenplay elements and ensemble-characters;
associate each ensemble-character with corresponding timeline-aware story metadata, behavioral archetypes, and psycholinguistic embeddings;
transmit only a timeline-constrained subset of the extended-script to a backend engine, thereby reducing network usage and computational overhead;
generate, at the backend engine, an ensemble-character simulation response by selectively invoking large language models restricted to the timeline-constrained subset and archetype embeddings; and
update, in real time, the inner-dialogue panel with the generated response while preserving multi-user editing consistency.

According to some embodiments, there is provided a non-transitory computer-readable medium storing instructions that, when executed by one or more processors, cause the processors to perform a method which includes one or more of the steps of:
receiving and parsing an extended-script including multiple characters and dialogues;
identifying ensemble-characters and associating them with corresponding behavioral and story-specific data;
transmitting script updates and character-interactions to a backend engine;
generating, using a coordinator module and a large language model, a simulated inner-dialogue response of an ensemble-character; and
displaying the simulated inner-dialogue response in a dedicated user interface panel synchronized with the extended-script.

According to some embodiments, the instructions may further cause the processor to generate a psycholinguistic-based wizard for defining personality archetypes.

According to some embodiments, the instructions may further cause the processor to selectively retrieve contextual story scenes relevant to the ensemble-character's knowledge at a screenplay point.

According to some embodiments, there is provided a user interface for a system configured to edit and simulate an extended-script, the user interface includes:
a story editor panel configured to present a textual representation of a screenplay, for example, with standard screenplay formatting;
an inner-dialogue panel configured to present simulated character responses generated by a backend engine;
a context-sensitive menu that, upon selecting a character name in the story editor panel, enables a user to initiate an inner-dialogue or script-dialogue interaction; and
a character management panel configured to display and edit ensemble-character profiles including backstories, psychological traits and/or behavioral tendencies.
According to some embodiments, the inner-dialogue panel displays a dynamic conversation thread comprising user-authored messages and in-character responses from an ensemble-character.

According to some embodiments, the story editor panel highlights ensemble-character names with visual markings and/or color coding to indicate role-play availability.

According to some embodiments, the character management panel may further include a behavioral wizard enabling a user to iteratively refine ensemble-character archetypes based on dynamically generated differentiating questions.

According to some embodiments, there is provided a graphical user interface for a computer system configured for collaborative extended-script editing and context-aware character simulation, the user interface includes:
a screenplay editing panel configured to render structured screenplay text with visual indicators for ensemble-characters;
an inner-dialogue panel configured to present a synchronized conversation thread between a user and a simulated ensemble-character generated by a backend engine;
a context-sensitive menu that, upon selection of a character name within the screenplay editing panel, triggers retrieval of timeline-relevant metadata and simulation of the selected character; and
a character management panel configured to allow definition and refinement of ensemble-character behavioral archetypes using dynamically generated differentiating questions derived from psycholinguistic models,
wherein the user interface integrates screenplay text, timeline-aware character metadata, and backend simulation responses in a single interactive environment that improves efficiency and reduces user cognitive load compared to conventional standalone editors.

According to some embodiments, there is provided a computerized method for multi-user collaborative editing of an extended-script in a story development environment (SDE) incorporating role-playing language agents, the method includes:
maintaining, in an extended-script storage, a canonical version of a story script including one or more ensemble-characters simulated by Character-Playing-Language-Agents (CPLA);
receiving, from a first user client, an update comprising at least one of a textual modification to the story script and a newly generated character-interaction with an ensemble-character;
receiving, concurrently from a second user client, a separate update comprising at least one of: a textual modification to the story script and a newly generated character-interaction with an ensemble-character;
synchronizing said updates by merging non-conflicting edits and resolving conflicting edits according to a predefined merge policy;
updating the canonical extended-script in the extended-script storage; and
broadcasting the synchronized updates in real time to all connected user clients, thereby enabling simultaneous collaborative editing of the extended-script and ensemble-character interactions.

According to some embodiments, the backend engine is configured to lock specific script segments to prevent conflicting edits by multiple users at the same timeline point.

According to some embodiments, conflicting edits may be automatically merged using a dedicated algorithm that preserves both textual changes and metadata of character-interactions.

According to some embodiments, the backend engine may maintain a version control for each extended-script, enabling users to revert to prior states after collaborative sessions.

According to some embodiments, updates generated by character-interactions are time-stamped and stored in a change log linked to the extended-script.

According to some embodiments, the live presence indicators are provided in the user interface showing which users are currently editing specific portions of the extended-script.

According to some embodiments, real-time collaborative editing is enabled across geographically distributed user clients via a cloud-based synchronization server.

According to some embodiments, character-interactions initiated by different users are contextually synchronized so that ensemble-character responses remain story-aware, scene-aware, and timeline-aware relative to the unified extended-script.

According to some embodiments, the backend engine is configured to support simultaneous multi-character dialogues initiated by different users in parallel collaborative sessions.

According to some embodiments, there is provided an SDE system (as defined herein) for story development, the system including: a) a frontend application and user interface for document editing adapted and configured for story editing and development; b) one or more Ensemble-characters (as defined herein); c) an integrated messaging application enabling messaging (e.g. by textual, visual and/or audible means), between: i) each user and the one or more Ensemble-characters; ii) a human user and plurality of Ensemble-characters.

According to some embodiments, the Ensemble-characters may be are deployed using CPLAs (as defined herein), adapted and configured to: a) role play specific story characters, in whichever story-specific environments, in whichever circumstances; b) receive various stimuli that may be related to specific points in the timeline of a story as reflected in the story text; c) generate content (e.g., textual) that is related to said stimuli and story context in the specific points in the timeline of the story; d) communicate said generated content within the document, or through the integrated messaging application.

According to some embodiments, the system is adapted to collaborative story development, wherein: a) Extended-scripts (as defined herein) are stored on cloud-based servers and storage; b) Extended-scripts are available and accessible to plurality of users for collaborative story editing and development through plurality of users interfaces; c) one or more computations and methods of the SDE are provided from a cloud-based architecture, servers and storage.

According to some embodiments, there is provided a computer-implemented method for document editing using the SDE system, the method includes: a) providing access to a user to the document editing and story development application, including Extended-scripts and Ensemble-characters; b) enabling a user to provide various stimuli to the Ensemble-characters, within the context of an Extended-script; c) generating textual content by the Ensemble-characters (technically generated by the respective CPLAs), in response to said stimuli; d) incorporating said generated textual content into the collaborative document or the integrated messaging application; c) enabling a user to interact with, and modify the Ensemble-characters generated content in the story development environment.

According to some embodiments, data structures of the various manifestations of the Extended-script may include pointers that tie the content of every Character Inner-dialogue to a story point within the story timeline in a way that enables the SDE to access every Character Inner-dialogue via said story point within the story timeline.

According to some embodiments, stimuli and response of Character Inner-dialogues (as defined herein) may be processed as follows: a) the CPLA simulating (role-playing) the Ensemble-character involved in said Inner-dialogue is getting access to it, and processes it as internal thoughts in the respective story character's mind; b) the CPLAs simulating (role-playing) other Ensemble-characters (that are not involved in said Inner-dialogue) are not exposed to the content of said Inner-dialogue.

According to some embodiments, response of the CPLAs simulating (role-playing) the Ensemble-characters, are based on story content of scenes and events the respective characters' are part of, or content that is part of their own backstory available in their profiles.

According to some embodiments, where applicable, various stimuli directed to Ensemble-characters are communicated using audio messages and transformed to text before transferred to their respective CPLAs, and their text responses are transformed back to audio before they are transferred back.

According to some embodiments, document editing using the SDE system is collaborative, providing access to plurality of human users to the collaborative document editing and story development application, including Extended-scripts and Ensemble-characters.

According to some embodiments, the method may further include presenting a user interface (or in the case of collaborative story development-plurality of user interfaces), adapted and configured with a main display area including: a) a story editing and interaction panel featuring formatted text collaborative document editing capabilities; b) a messaging application panel enabling messaging between a user (or users) and the Ensemble-characters of the story currently edited, including conducting Character Inner-dialogues (as defined herein); c) an Ensemble-characters configuration and adaptation panel;

According to some embodiments, the story editing and interaction panel of the User interface, provides a context sensitive menu, that can be activated in every story point in the timeline of the story text, with various options, including the option to initiate various Character-interactions (as defined herein) that are attached to said story points in the timeline of the story.

According to some embodiments, the story editing and interaction panel of the UI includes special markings for: a) Ensemble-characters names-differentiating them from non-Ensemble-characters names; b) every instance of text within the story text (including Ensemble-characters names) that is attached to some Character-interactions.

According to some embodiments, the messaging application panel of the UI, includes standard chat application controls, enabling a user to edit and/or delete and/or scroll to, and view every single message within every messaging session, including, edit and/or delete of all user messages and all the Ensemble-character's responses).

According to some embodiments, the messaging panel of the UI enables audio messages.

According to some embodiments, the Ensemble-characters are adapted, configured or fine-tuned to portray story characters, in any story-specific environment, in any circumstances. According to some embodiments, the method includes any combination of: a) user provided free-format text descriptions of said character; b) user provided reference to one or more fictional or real characters on which the Ensemble-character's personality may be based on, and where some personality traits from said fictional or real character are extracted from publicly available texts and utterances attributed to said fictional or real character, and where the user may edit the extracted traits; c) a wizard-like process where some personality traits or Behavioral patterns (as defined herein) of the Ensemble-character are derived from personality traits and Behavioral patterns of a plurality of archetypal characters personalities.

According to some embodiments, potential Behavioral patterns of the Ensemble-character may be extracted and synthesized from a combination of archetypal characters that are similar to said Ensemble-character, comprising a combination of: a) a similarity measure between the portrayal of said Ensemble-character and each of a plurality of characters archetypes; b) a set of dynamically computed character descriptors that may be presented to the user, and where a selection between them by a user, according to their fit to said Ensemble-character, enables said wizard-like process to differentiate between a plurality of characters archetypes that may be similar to the portrayal of the Ensemble-character, resulting in a sub list of the most similar characters archetypes.

According to some embodiments, an existing story (e.g. a book) may be adapted and developed into a screenplay in the SDE, by: a) creating an Ensemble-character for each of the main written work main characters; b) configuring and extracting said written work characters' personalities and Behavioral patterns from a combination of: i) the text of said written work; ii) publicly available texts and utterances attributed to said written work characters; iii) expert psychological assessment of said written work characters' personalities and Behavioral patterns; c) having a screenwriter develop and adapt the original written work into a screenplay, within the SDE, helped by the existing Ensemble-characters that role-play the original written work main characters.

According to some embodiments, one or more screenplays of one or more stories or episodes with a similar cast of main characters may be developed or extended into additional screenplays or stories or episodes in the SDE by: a) creating an Ensemble-character for each of said cast of main characters; b) configuring and extracting said cast of main characters' personalities and Behavioral patterns from a combination of: i) the text of said one or more screenplays of one or more stories or episodes; ii) publicly available texts and utterances attributed to said cast of main characters; iii) expert psychological assessment of said cast of main characters' personalities and Behavioral patterns; c) having one or more screenwriters develop or extend the original one or more screenplays of one or more episodes of one or more stories into new screenplays, episodes or stories within the SDE, helped by the existing Ensemble-characters that role-play said cast of main characters of one or more screenplays of one or more episodes of one or more stories.

According to some embodiments, the UI may further include: a) a panel providing: i) showing all existing Ensemble-characters; ii) user interface controls to add a new Ensemble-character; iii) user interface controls to select an existing an Ensemble-character; iv) user interface controls to delete an existing Ensemble-character; v) user interface controls to edit an existing Ensemble-character profile; b) a panel for configuring an Ensemble-character description and personality;

According to some embodiments, the UI may be adapted and configured to reference one or more known fictional characters on which the Ensemble-character's personality may be based on.

According to some embodiments, the UI may be adapted and configured to provide a wizard comprising: a) a dynamically computed list of questions posed to a user; b) a proposed list of possible Behavioral patterns that are relevant to the psychological profile of the Ensemble-character.

According to some embodiments, the methods disclosed herein may utilize any type of suitable algorithms, including, for example, but not limited to: artificial neural network(s) (ANN), such as convolutional neural network (CNN), recurrent neural network (RNN), long-short term memory (LSTM), auto-encoder (AE), generative adversarial network (GAN), Reinforcement-Learning (RL), support vector machine (SVM), decision tree (DT), random forest (RF), and the like. Both “supervised” and “unsupervised” methods may be implemented. As further detailed herein, the AI algorithm may utilize various types of data, information, parameters, values and/or any information derived therefrom, for the management of the virtual inventory, for the creation, updating and pricing of an STIN, for the creation and/or updating of the IIN, and the like, or any combination thereof. In some embodiments, the generative AI engine may implement any suitable machine learning algorithm or ensemble of algorithms, including but not limited to: neural networks (e.g., CNN, RNN, LSTM, Transformers), probabilistic models (e.g., HMM, Bayesian networks), decision tree-based methods (e.g., random forests, gradient boosting), unsupervised learning techniques (e.g., K-means clustering, PCA), and reinforcement learning methods (e.g., Q-learning, actor-critic architectures), or any combinations thereof.

In the description and claims of the application, the words “include” and “have”, and forms thereof, are not limited to members in a list with which the words may be associated.

Unless otherwise defined, all technical and scientific terms used herein have the same meaning as commonly understood by one of ordinary skill in the art to which this disclosure pertains. In case of conflict, the patent specification, including definitions, governs. As used herein, the indefinite articles “a” and “an” mean “at least one” or “one or more” unless the context clearly dictates otherwise.

It is appreciated that certain features of the disclosure, which are, for clarity, described in the context of separate embodiments, may also be provided in combination in a single embodiment. Conversely, various features of the disclosure, which are, for brevity, described in the context of a single embodiment, may also be provided separately or in any suitable sub-combination or as suitable in any other described embodiment of the disclosure. No feature described in the context of an embodiment is to be considered an essential feature of that embodiment, unless explicitly specified as such.

Although stages of methods according to some embodiments may be described in a specific sequence, methods of the disclosure may include some or all of the described stages carried out in a different order. A method of the disclosure may include a few of the stages described or all of the stages described. No particular stage in a disclosed method is to be considered an essential stage of that method, unless explicitly specified as such.

Although the disclosure is described in conjunction with specific embodiments thereof, it is evident that numerous alternatives, modifications and variations that are apparent to those skilled in the art may exist. Accordingly, the disclosure embraces all such alternatives, modifications and variations that fall within the scope of the appended claims. It is to be understood that the disclosure is not necessarily limited in its application to the details of construction and the arrangement of the components and/or methods set forth herein. Other embodiments may be practiced, and an embodiment may be carried out in various ways.

The present invention may be a system, a method, and/or a computer program product. The computer program product may include a computer readable storage medium (or media) having computer readable program instructions thereon for causing a processor to carry out aspects of the present invention.

A computer program (also referred to as a program, software, software application, script or code) can be written in any form of programming language, including compiled or interpreted languages, declarative or procedural languages, and it can be deployed in any form, including as a standalone program or as a module, component, subroutine, object, or other unit suitable for use in a computing environment. A computer program may, but need not, correspond to a file in a file system. A computer program can be stored in a portion of a file that holds other programs or data, in a single file dedicated to the program in question, or in multiple coordinated files (for example, files that store one or more modules, sub programs or portions of code). A computer program can be deployed to be executed on one computer or on multiple computers that are located at one site or distributed across multiple sites and interconnected by a communication network.

Computer readable program instructions described herein can be downloaded to respective computing/processing devices from a computer readable storage medium or to an external computer or external storage device via a network, for example, the Internet, a local arca network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, for example, JavaScript, Smalltalk, C, C++, TypeScript, Python and R.

The computer readable program instructions may execute entirely on the user's computer, partly on the user's computer, as a stand-alone software package, partly on the user's computer and partly on a remote computer or entirely on the remote computer or server (such as, a cloud based). In the latter scenario, the remote computer (or cloud) may be connected to the user's computer through any type of network, including a local area network (LAN) or a wide arca network (WAN), or the connection may be made to an external computer (for example, through the Internet using an Internet Service Provider) including wired or wireless connection (such as, for example, Wi-Fi, BT, mobile, and the like). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention. Moreover, a computer can be embedded in another device, for example, a mobile phone, a tablet, a personal digital assistant (PDA, or a portable storage device (for example, a USB flash drive). Devices suitable for storing computer program instructions and data include all forms of non-volatile memory, media and memory devices, including semiconductor memory devices, for example, EPROM, EEPROM, random access memories (RAMs), including SRAM, DRAM, embedded DRAM (eDRAM) and Hybrid Memory Cube (HMC), and flash memory devices; magnetic discs, for example, internal hard discs or removable discs; magneto optical discs; read-only memories (ROMs), including CD-ROM and DVD-ROM discs; solid state drives (SSDs); and cloud-based storage. The processor and the memory can be supplemented by, or incorporated in, special purpose logic circuitry.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The processes and logic flows described herein may be performed in whole or in part in a cloud computing environment. For example, some or all of a given disclosed process may be executed by a secure cloud-based system comprised of co-located and/or geographically distributed server systems. The term “cloud computing” is generally used to describe a computing model which enables on-demand access to a shared pool of computing resources, such as computer networks, servers, software applications, and services, and which allows for rapid provisioning and release of resources with minimal management effort or service provider interaction.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

While certain embodiments of the invention have been illustrated and described, it will be clear that the invention is not limited to the embodiments described herein. Numerous modifications, changes, variations, substitutions and equivalents will be apparent to those skilled in the art without departing from the spirit and scope of the present invention as described by the claims, which follow.

What we claim is:

1. A computerized method for providing a story development environment (SDE) generating and/or updating a story incorporating role-playing language agents, the method comprising:
i) receiving, by a backend engine, an extended script;
ii) if the extended-script does not comprise an ensemble-character, defining at least one ensemble-character, being configured with a character profile, and implemented as a Character-Playing-Language-Agent (CPLA), to enable simulation of contextual Point Of View(s) (POV) of the ensemble-character at any point-in-time along the story progression;
iii) for any point in time along the story progression and any ensemble-character, dynamically generating a context for a potential POV of the ensemble-character, utilizing the backend engine, a CPLA coordinator module and an extended-script storage, wherein the context comprises: filtered story history of the character comprising only scenes that are relevant to the ensemble-character at said point in time and/or until said point in time, inner-dialogue(s) of the ensemble-character at and until said point in time, personality and behavioral patterns of the ensemble-character, or any combinations thereof;
iv) generating, utilizing the backend engine, the CPLA coordinator module, and the context, a simulated response of the ensemble character, wherein a response describes what the ensemble-character think, feel, plan, act and/or say, wherein the simulated response manifestation comprises a character inner-dialogue stream associated with any point in time within the story progression, an off-screen dialogue between multiple ensemble-characters, an in-story dialogue entry and/or an in-story description entry;
v) integrating the simulated response of the ensemble-character into the extended script; and
vi) updating the extended-script storage with the most updated extended script.

2. The method of claim 1, wherein defining the at least one ensemble-character further comprises dynamically computing a similarity measure between the ensemble-character description and a plurality of predefined psycholinguistic personality archetypes stored in a database, and automatically deriving behavioral patterns for the character, from behavioral patterns of the most similar predefined archetypes.

3. The method of claim 1, wherein integrating the simulated response into the extended script comprises utilizing specific metadata tags to enable:
identification and retrieval of additional context to be utilized in other POVs;
identification, retrieval and/or visual representation of the POV(s).

4. The method of claim 1, wherein the backend engine is further configured to generate simulated response(s) for multiple ensemble-characters simultaneously, within a shared extended-script.

5. The method of claim 1, further comprises allowing multiple users to simultaneously interact with one or more ensemble-characters in parallel.

6. A system for generating and/or updating a story incorporating role-playing language agents in a story development environment (SDE), the system comprises one or more processors configured to execute the method of claim 1.

7. A user interface for a story development environment (SDE) incorporating role-playing language agents, the user interface comprising:
i) a story editing panel configured to:
a) display and/or edit a textual representation of an extended-script of the story, comprising character names, scenes, POVs, dialogues and/or inner dialogues;
b) visually differentiate characters that are ensemble-characters from non-ensemble-characters; and
c) visually indicate, by indicators, associations between points-in-time along the story progression and ensemble-characters' POV and/or inner-dialogues, wherein selection of said indicator enables initiation of an interaction with the ensemble-character at that point-in-time;
ii) ensemble character panel configured to generate ensemble character(s); and
iii) a character interaction panel configured to display a stream of interactions between a user and at least one ensemble-character;
wherein the user interface is configured to dynamically retrieve and/or update the extended-script from and/or to a backend engine.

8. The user interface of claim 7, wherein the indicator further enables the user to select at least one of: initiating an inner-dialogue, initiating a script dialogue, or invoking an ensemble-character creation wizard.

9. The user interface of claim 7, wherein the ensemble character panel comprises a behavioral wizard configured to dynamically generate differentiating questions based on an evolving internal psychological model of the ensemble-character.

10. The user interface of claim 9, wherein the behavioral wizard is further configured to enable selection of a subset of potential behavioral patterns, derived from the psychological model of the ensemble-character.

11. The user interface of claim 7, wherein the ensemble-character panel facilitates collaborative multi-user editing of the extended script, by displaying indicators for other users currently modifying the same extended-script.

12. A computerized system for generating and/or updating a story incorporating role-playing language agents in a story development environment (SDE), the system comprising:
i) a backend engine comprising:
(1) a CPLA coordinator module configured to simulate an ensemble-character by dynamically generating a context for the POV of the ensemble-character, wherein the context comprises: filtered story history of the character comprising only scenes that are relevant to the ensemble-character at said point in time and/or until said point in time, inner-dialogue(s) of the ensemble-character at and until said point in time; personality and behavioral patterns of the ensemble-character, or any combinations thereof;
(2) a set of one or more large language models and CPLA models trained on behavioral data for role-playing story characters; and
(3) an extended-script storage for storing a story text extended with character's POVs and metadata tags and
ii) an interface configured to enable communication between frontend modules of one or more users and the backend engine;
wherein the system is configured to maintain consistency of the POVs of ensemble-characters along any point in time within the story progression.

13. The system of claim 12, wherein the backend engine and the frontend modules are functionally associated on a common computation device.

14. The system of claim 12, wherein the interface is a network interface and wherein the backend engine and the frontend modules are executed on separate computing devices.

15. The system of claim 12, wherein the backend engine further comprises a behavioral archetype database mapping personality traits to expected behavioral patterns for character simulation.

16. The system of claim 12, wherein the backend engine further comprises a behavioral archetype module configured to dynamically compute a similarity measure between the ensemble-character description and a plurality of predefined psycholinguistic personality archetypes stored in a database, and automatically derive behavioral patterns for the character, from behavioral patterns of the most similar predefined archetypes.

17. The system of claim 12, wherein the CPLA coordinator module is configured to orchestrate both internal language models and external large language model APIs, to generate ensemble-character simulations.

18. The system of claim 12, wherein the backend engine is configured to dynamically filter story history of the ensemble character, comprising only scenes that are relevant to the ensemble-character at a point in time and/or until said point in time of the story, inner-dialogue(s) of the ensemble-character at and until said point in time, or any combinations thereof.

19. The system of claim 12, wherein the CPLA coordinator module is configured to support multi-ensemble character dialogues, wherein multiple ensemble-characters engage in a simulated off-screen conversation, independent of a user.

20. The system of claim 12, wherein the backend engine is deployed in a distributed computing architecture comprising cloud servers and local processing units.
